(19) United States
(12) Patent Application Publication
(10) Pub. No.: US 2013/0259994 A1
(43) Pub. Date: Oct. 3, 2013

(54) Fluids - solids separating / essence exchanging apparatus

(71) Applicant: Sastry K. Ganti, Buffalo Grove, IL (US)

(72) Inventor: Sastry K. Ganti, Buffalo Grove, IL (US)

(21) Appl. No.: 13/573,409

(22) Filed: Sep. 14, 2012

Related U.S. Application Data
(60) Provisional application No. 61/685,895, filed on Mar. 28, 2012.

(51) Int. Cl. A47J 31/06

(52) U.S. Cl. CPC A47J 31/06
USPC 426/433; 210/435; 210/767; 426/431; 426/435

(57) ABSTRACT

A vertical apparatus,—for mixtures of solids & liquids,—used to exchange essence between them,—or used to separate solids from liquids or vice a versa,—placed on the inside floor of a container, has:
(1) an outer & (2) an inner parts, both substantially, cylindrically shaped, open ended, loose yet close fitting, & concentrically nested, with the outer part having an integral seal ring at its bottom end, and (3) a horizontal filter element covering the inner part's bottom opening, it being held clamped between the close fitting substantially cylindrical parts.

With fluids placed inside the apparatus, they remain there without leaking past the seal ring, until the apparatus is lifted off of the container floor to unseal & filter the fluids into the container.

### CROSS-REFERENCE TO RELATED APPLICATION

This application claims the benefit of provisional patent application Ser. No. 61/685,895, filed 2012 Mar. 28, confirmation number 9038.

### FEDERALLY SPONSORED RESEARCH

Not applicable

### SEQUENCE LISTING OR PROGRAM

Not Applicable

### BACKGROUND OF THE INVENTION

1. Field of Invention

The invention relates to, exchange of essences between solids and fluids and their separation, in an efficient manner by using a compact vertical apparatus placed on inside floor of a container, and the utilization of the apparatus. Coffee brewing will be described primarily to elaborate the new art's ideas. In such elaboration, what is meant by coffee powder is,—the result of pulverizing roasted coffee beans. The ideas may be applied to brewing tea also. In case of tea brewing what is meant by tea leaves is,—full size tea leaves or tea leaves pulverized to smaller size.

The apparatus and methods are also appropriate for simply separating wanted fluids from mixture with unwanted solids, or simply separating wanted solids from mixture with unwanted fluids.

2. Prior Art

Brewing hot coffee is a very common example of extracting essence from coffee powder, using hot water as the fluid medium and a coffee pot as the apparatus. The normal ubiquitous ‘coffee pot’ apparatus of prior art generally consists;
A) a hot water dispenser at the top and rear of the apparatus, and
B) a horizontally removable conical housing with a filter element, and
C) a horizontally removable container for the brewed coffee to drain into, and
D) an electrical warmer plate underneath the coffee container.

The vertical stack-up for prior art adds up to the cumulative height of parts stated above except for the water containing unit at rear of the apparatus.

Hot water is piped up from rear to above and over the coffee powder that has been placed inside a filter element's conical hollow, and then released. Released hot water extracts essence from coffee powder as it descends and contacts it.

There are numerous types of prior art apparatuses but a majority of them share the common process step of water under the influence of gravity flowing over coffee powder, and then the water enriched with coffee essence drains into a receiving container placed below.

Disadvantages of prior art as applied to brewing hot coffee:
1) once the water is released into the brewing space, it is freed with no further control over its flow dynamics;
2) gravity alone and initial conditions at water's release influence the water's dynamics,—till it is about to contact the coffee powder and the filter element;
3) once the released water contacts the coffee powder, gravity, the changing characteristics of the wet coffee powder, the wet filter element and the conical housing control how the water will behave, where, the flow may rearrange the coffee powder & the filter element in a disadvantageous way;
4) a released water droplet contacts only the coffee powder that it can in its path and no other;
5) the water's motion is always predominantly downwards along the filter wall and thus is restricted;
6) in a sense only the water is in motion and not the coffee powder;
7) no agitation of water with coffee powder is normally feasible;
8) the amount of essence extracted from any given quantity of coffee powder will vary from another given quantity located elsewhere in the brewing space;.
9) in some contact regions the essence extraction may be prolonged & repeated resulting in extraction of undesirable flavors and compounds; in other regions the amount of essence extraction may not be complete;
10) lack of control after release of water necessitates an elaborate design of the brewing space to achieve essence extraction efficiency;
11) the contact time between any given quantity of water and the coffee powder in its path is brief, uncontrolled and limited by the dynamics described;
12) the filtering equipment stacked up vertically occupies extra space due to the filter element cone housing & lacks compactness;
13) as a compensating measure against inefficiency of essence extraction, more of coffee powder is required to brew a specified amount of coffee;
14) The coffee is generally brewed in fixed amounts, leading to same type of coffee for all drinkers, and possibly causing wastage when it is not completely consumed;
15) removing the coffee container horizontally results in the filter element housing dripping on to whatever is below;
16) removing the filter element housing horizontally results in drips from the housing as well as the hot water supply spray unit;
17) the filter element is conical and thus necessitates a larger area filter element than a flat one;
18) the conical filter element necessitates shape forming machinery;
19) the conical shape of the brewing space and lumping of wet coffee powder results in a slower draining of the brew;
20) the wet coffee powder slides towards the bottom of the cone and impedes effective essence extraction & draining;
21) the strength of the brew varies continuously as the coffee drains.

### OBJECTS AND ADVANTAGES

Accordingly, the objects and advantages of the new art are as follows, applied to brewing hot coffee as the example:
1) the water is contained in the brewing space for any duration of brewing;
2) gravity does not dictate the dynamics of the brewing water;
3) once the released water contacts the coffee powder they both stay confined with intimate contact for any desired duration;
4) all of the water can contact all of the coffee powder all of the duration;
5) the water's motion can be made to be turbulent and all-directional;
6) both the water and the coffee powder are in random motion while mingling with each other;
7) agitation or mixing of water and coffee powder intimately is possible by simple means such as stirring with a spoon;
8) the amount of essence extraction from any given quantity of coffee powder will be uniform in comparison with a different quantity;
9) apart from obtaining uniform essence extraction, by controlling the brewing time, extraction of undesirable flavors and compounds can be avoided;
10) the apparatus requires no complicated design, but sufficient for plain addition of all the hot water & all the coffee powder in either order;
11) all the coffee powder is in contact with the water for the same time;
12) the filtering equipment is nested inside the receiving container, and hence it conserves counter space by being compact;
13) minimal amount of coffee powder is needed to obtain a required amount of coffee of the required strength;
14) since the new art is suitable for brews of any desired quantity and quality, different individuals can have individual brews of their liking with no wastage;
15) the coffee powder & the container are lifted vertically, which gives control with drips, which can fall into the container;
16) the brewing apparatus and the coffee receiving container can be moved as a unit, for instance, over a sink, thus giving additional control on any drips;
17) the filter element is flat and hence apart from having efficient area usage, its packaging & marketing become simpler;
18) no ‘cone shape forming apparatus’ is required for the flat filter element;
19) the flat filter element presents a fast drain for the coffee;
20) the inner wall of the apparatus can be constructed to trap a fraction of the wet powder during filtering & that gives more unimpeded draining area at the filter element;
21) the filtered brew has uniform strength.

### SUMMARY

By comparing the advantages of the new art over prior art, the reader will note that the coffee brewing apparatus of the new art, while occupying less space, will brew better and more coffee, more uniformly, more economically and more quickly than prior art apparatus for the same amount of coffee powder, while giving better cleanliness due to better control of unsightly drips.

ACRONYMS representing phrases used in the new art descriptions:
CWA=Container Warming Apparatus
ECI=Essence Containing Ingredients
EEA=Essence Extracting Apparatus
EEF=Essence Extracting Fluid
ERC=Essence Receiving Container
HRC=Heat Retaining Cover

### DRAWINGS

### Figures

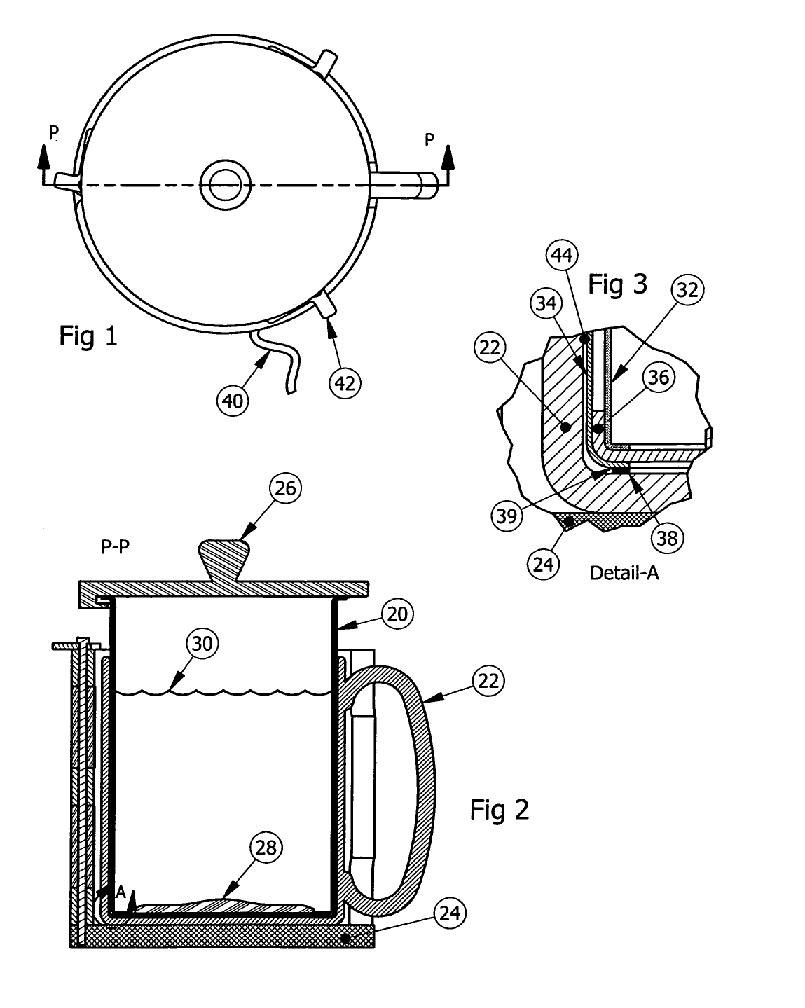

FIG. 1 Top View of EEA in extracting position with ERC, HRC & CWA

FIG. 2 Sectional View-PP, a front elevation of FIG. 1

FIG. 3 Enlarged view ‘Detail-A’ of a portion of FIG. 2

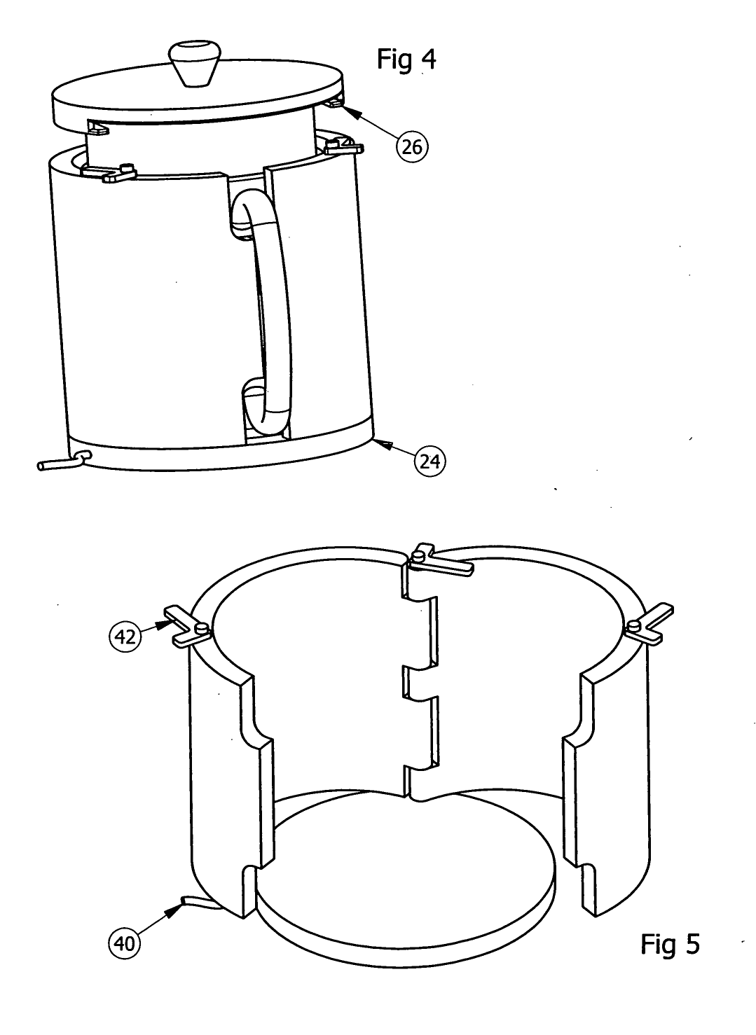

FIG. 4 Perspective View of EEA in extracting position with ERC, HRC & CWA

FIG. 5 CWA shown in an open stance

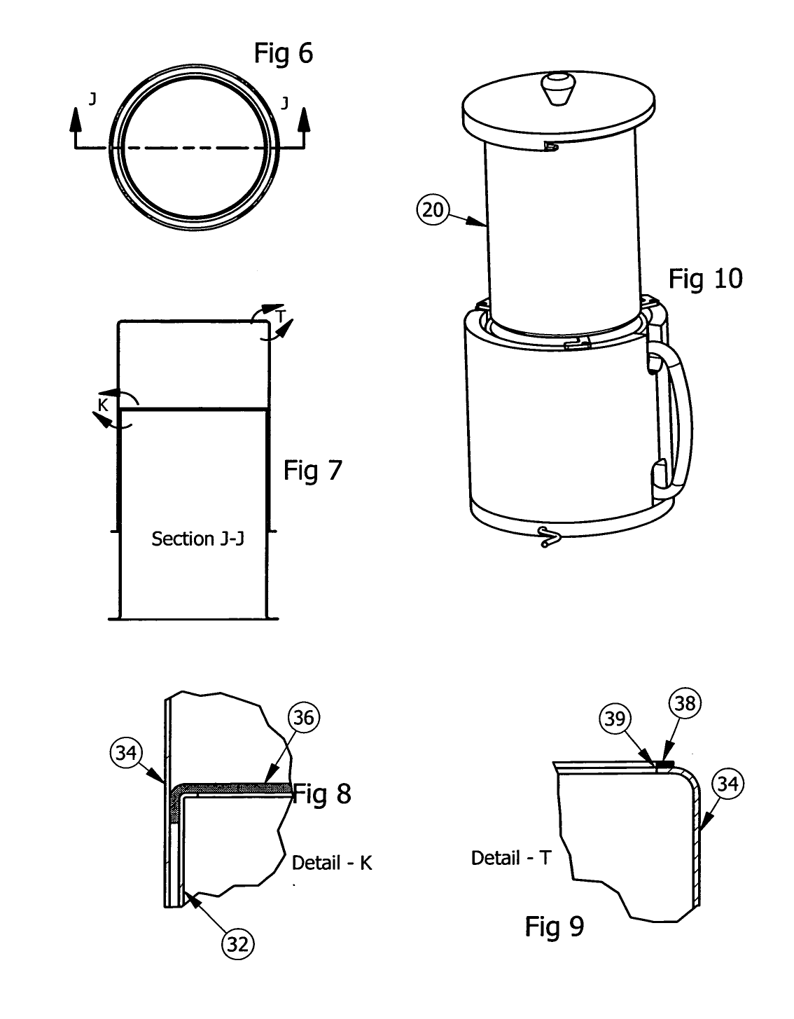

FIG. 6 Top View of inverted EEA

FIG. 7 Sectional View-JJ of FIG. 6 (front elevation)

FIG. 8 Enlarged View, Detail-K of one portion of FIG. 7

FIG. 9 Enlarged View, Detail-T of another portion of FIG. 7

FIG. 10 Perspective View of EEA, in draining position, with ERC, HRC & CWA

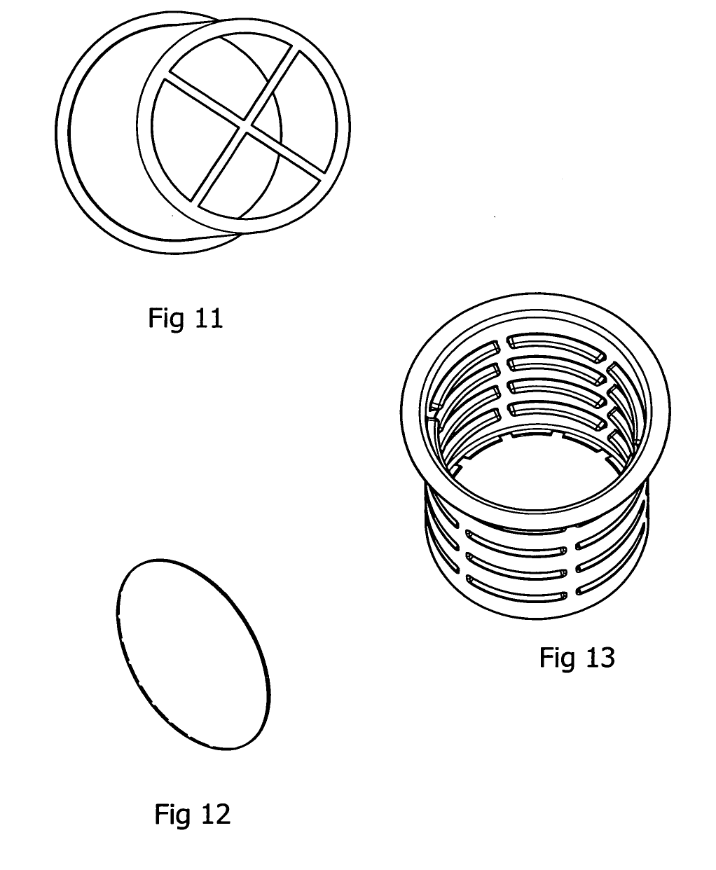

FIG. 11 Outer Member of EEA with Ribs at bottom

FIG. 12 Flat Filter Element for EEA

FIG. 13 Inner Member of EEA with projecting Internal Ridges

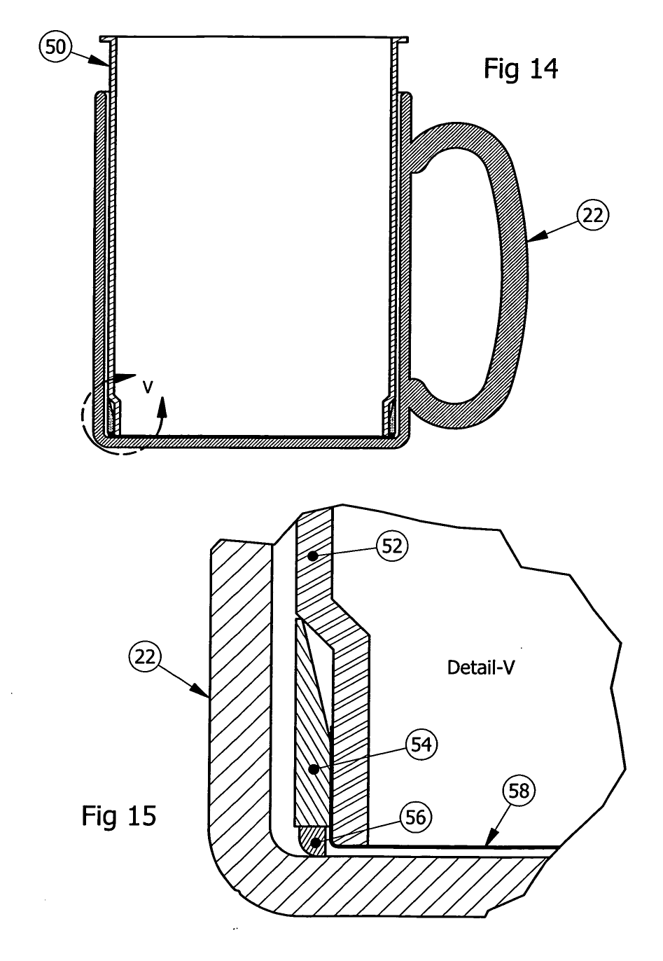

FIG. 14 Alternate Embodiment of EEA in extracting position with ERC

FIG. 15 Enlarged view ‘Detail-V’ of a portion of FIG. 14

### REFERENCE NUMERALS

20 (EEA) Essence Extracting Apparatus
22 (ERC) Essence Receiving Container
24 (CWA) Container Warming Apparatus
26 (HRC) Heat Retaining Cover
28 (ECI) Essence Containing Ingredients
30 (EEF) Essence Extracting Fluid
32 Inner Member of EEA
34 Outer Member of EEA
36 Filter Element of EEA (thickness exaggerated for clarity)
38 Sealing Member of EEA, integral (or fastened) to #34
39 Bonding surface for Sealing Member #38
40 Electrical Cable at CWA
42 Swing Lever, typical, at CWA
44 Annular Vertical Gap between EEA & ERC
50 EEA of Alternate Embodiment
52 Inner Member of EEA, . . . —Alternate Embodiment
54 Outer Clamping Member of EEA,—Alternate Embodiment
56 Integral Sealing Member of EEA,—Alternate Embodiment
58 Filter Element of EEA,—Alternate Embodiment

### DETAILED DESCRIPTION & OPERATION OF PREFERRED EMBODIMENT

Preferred embodiment is elaborated for brewing hot coffee as the example. Though the EEA in all illustrations depicts plain cylinders, conical shape will also work. EEA in the new art form is depicted as #20 (FIG. 2, sectional view of FIG. 1). #20 is comprised, as an unfastened assembly of three items (FIG. 3 Detail-A):
#32 the Inner Member, and
#34 the Outer Member, with the integral #38 Sealing Member, and
#36 the trapped Filter Element.

These three items can be quickly put together as an inverted assembly shown in FIGS. 6, 7, and 8. Initially the flat Filter Element #36 can be placed over the Inner Member #32. By running a wet finger along the rim before placing Filter Element #36 it may be made to stick and be stable. Once the Outer Member #34 is slipped over, the Filter Element #36 is slightly deformed and stays trapped.

FIG. 11 shows an Outer Member #34 having (optionally) ribs at its bottom surface. The ribs stabilize and support the Filter Element #36. The Inner Member #32 may also have such ribs to assist firmer entrapment of the Filter Element #36.

FIG. 12 shows the Filter Element #36 as flat before insertion into the EEA.

FIG. 13 shows an Inner Member with inwardly projected ridges (optional). Their purpose is to encourage a portion of the wet ECI to adhere to them so that lesser amount of the wet ECI adheres on the Filter Element #36 during draining of the enriched EEF; such a design will speed up the draining process. Instead of ridges, just coarse & rough internal surface or a multitude of rough bumps will give similar benefit.

FIG. 3 (detail-A or FIG. 9 Detail-T) show a Sealing Member #38 (or #56). Its purpose is to prevent any premature escapement of the EEF from the Inner Member #32 to occupy the ring shaped Vertical Gap #44 between Outer Member #34 (or #52 FIG. 14) and ERC #22 (FIGS. 2, 15). The preferred design is to have the Sealing Member #38 to be integral with the Outer Member #34 (at #39), as bonded or sprayed & cured polymer, forming an effective seal of compliant material.

A similar but inconsequential gap between Outer Member #34 & Inner Member #32 is dictated by the thickness and forming behavior of the Filter Element #36 (FIG. 3).

Referring to FIG. 3, it can be seen that the outer dimension of Outer Member #34 is made to closely conform to inner dimension of ERC #22, and yet easy insertion and removal of EEA with ERC is to be facilitated. Sealing Member #38 is made as thin as practical so that the unavoidable quantity of EEF that escapes past the Filter Element #36 during essence extraction is kept to bare minimum.

Referring to FIG. 2, #24 is the CWA that is constructed with pivoting half shroud like thermal insulating doors (FIG. 5). #40 is the electrical cable leading to a heating element (not shown) inside CWA. With the ERC & EEA placed inside the CWA, pre-warming of ERC and EEA can take place,—say for hot coffee (or tea) brewing. Inside the EEA, the ECI (#28 FIG. 2) are placed and hot EEF (#30 FIG. 2) is poured. The order of introducing ECI (#28 FIG. 2) and EEF (#30 FIG. 2) is not important to presenting the ideas of new art. If desired the two brewing ingredients are stirred to obtain a good mix. #26 HRC (FIG. 2) is slid on to maintain the temperature of the mix of ECI (#28 FIG. 2) and EEF (#30 FIG. 2). HRC's knob shown at its top facilitates easy handling the HRC singly or together with EEA and its contents.

While FIG. 4 shows a perspective view representing the EEA in its essence extracting position inside the ERC with CWA and HRC, FIG. 10 shows the EEA lifted and resting on Swing Levers #42 (FIG. 1) that have been turned radially inwards. Once the draining of the EEF into ERC is complete, the EEA and the ERC can be removed from the CWA, singly or together as a unit.

With the HRC#26 as shown (FIGS. 2, 4, and 10), the assumption is that hot water (FIG. 2, EEF #30) is obtained from elsewhere, such as a microwave oven or a kitchen range. Here the reader is made aware of an alternative HRC not shown in the drawings; the HRC #26 as shown may be replaced with a fully self operational ‘EEF dispenser’ that also functions as a HRC. For coffee brewing this would be a hot water dispenser that will in addition function as a HRC by being placed on top of EEA #20 (or #50). In functionality this portion of the equipment would mimic prior art in a sense that it would heat the water poured into it and automatically dispense the heated water into the EEA underneath.

### Description and Operation

### Alternative Embodiment

FIGS. 14 & 15 show an alternate embodiment of the EEA.

Here the EEA #50 is composed of the three items:
Inner Member of EEA #52, and
the ‘clamp ring style’ Outer Member #54, wherein
   the Seal Ring #56 is integral to Outer Member #54, and
Filter Element #58.

When the Outer member #54 is inserted over the Filter Element #58, it exerts the required circumferential clamping action on it to secure the Filter Element #58. The rapid assembly procedure of the three parts and operation of this embodiment can be same as described in the preferred embodiment. The Outer Member #54 may be constructed as an open overlapping “C” (that is,—a ring with variable girth & with overlapping ends) supplying a predesigned clamping force after placement.

### OTHER RAMIFICATIONS AND SCOPE

Use of a Rectangular (or Square) Filter Element:
Contrasting the circular shaped ERC #22 & EEA #16 of FIGS. 1 & 2 that use a conforming circular shaped Filter Element of FIG. 12, with a possible rectangular, square, or other shaped ERC, a suitable rectangular (or square) shaped EEA can be used, in which case the Filter Element would be a rectangle (or a square).

The advantage here would be that the Filter Element can be supplied conveniently in roll form, and can be cut to length as and when required.

Using the EEA as a Debris Separator:

In instances where fluid is mixed with undesired debris, normal filtering with flow through fluid stream against a Filter Element is employed to arrest the debris by the Filter Element.

Yet in case where debris particles are heavy, and/or excessive debris momentum may exist in a flow through separator, filter element is prone to damage even if it is of heavy gage wire meshes. In such cases the new art may be utilized. The described EEA is turned into a debris removing separator and the fluid free of debris is filtered into the receiving container. The Filter Element is safe from damage since it is backed up by the floor of the Receiving Container during pouring of the debris laden fluids.

Using the EEA as a Reverse Extractor:

By reverse extraction, it is implied that solids remove essence from liquids. For reverse extraction the apparatus and the methods are the same as used for normal extraction of essence by fluids from solids.

Using Cone Shaped EEA:

The inner and outer members of the EEA can be nested cones that may rest inside an adequate container of any shape. The seal and the Filter Element can still remain simple circles.

I claim:

1. A vertical, fluid solid separating apparatus placed on the inside floor of a container, said separating apparatus comprising:
(a) an outer substantially cylindrical part substantially open at both ends, and
(b) a seal on the substantially horizontal annular surface at the bottom of said outer substantially cylindrical part, and
(c) an inner substantially cylindrical part substantially open at both ends wherein said inner substantially cylindrical part is substantially concentrically nested inside said outer substantially cylindrical part, and
(d) a filter element placed substantially horizontally to cover the bottom opening of said inner substantially cylindrical part, with means for said filter element to maintain the covering position of said filter element,
whereby any fluid placed inside said inner substantially cylindrical part will not escape past said seal.

2. Said seal of claim 1 comprising substantially a polymer ring bonded to said annular surface at the bottom of said outer substantially cylindrical part.

3. Said seal of claim 1 comprising substantially sprayed polymer compound on said annular surface at the bottom of said outer substantially cylindrical part.

4. A method of utilization for said separating apparatus of claim 1 to exchange essences within a mixture of a plurality of solids and a plurality of fluids, wherein said method of utilization comprises the steps of,
placing said fluids and said solids inside said inner substantially cylindrical part of said separating apparatus, and
allowing the exchange of said essences between said fluids and said solids to take place, and thereafter
lifting said separating apparatus off of said container,
whereby the modified solids from said solids due to said exchange, remain in said separating apparatus, and
the modified liquids from said liquids due to said exchange, drain into said container.

5. Said method of utilization of claim 4 to brew coffee, wherein said plurality of solids is coffee powder and said plurality of fluids is water.

6. Said method of utilization of claim 4 to brew tea, wherein said plurality of solids is tea leaves and said plurality of fluids is water.

7. A method of utilization of said separating apparatus of claim 1 for separating a plurality of fluids mixed with a plurality of solids, into a mixture of said fluids separated from a mixture of said solids,
wherein said utilization comprises the steps of,
placing said plurality of fluids mixed with said plurality solids inside said inner substantially cylindrical part of said separating apparatus, and thereafter lifting said separating apparatus off of said container,
whereby said plurality of solids will remain within said separating apparatus, and said plurality of fluids will separate into said container without damaging said filter element.
